(19) United States
(12) Patent Application Publication
(10) Pub. No.: US 2016/0029687 A1
(43) Pub. Date: Feb. 4, 2016

(54) Method and apparatus to yield large kernels from Black Walnuts

(71) Applicant: David Harold Berry, Mountain Home, AR (US)

(72) Inventor: David Harold Berry, Mountain Home, AR (US)

(73) Assignee: BERRY INNOVATIVE SOLUTIONS LLC, Mountain Home, AR (US)

(21) Appl. No.: 14/806,806

(22) Filed: Jul. 23, 2015

Related U.S. Application Data
(60) Provisional application No. 62/030,760, filed on Jul. 30, 2014.

(51) Int. Cl. A23N 5/00; A23L 1/36

(52) U.S. Cl. CPC A23N 5/00; A23L 1/362; A23V 2002/00

(57) ABSTRACT

An improved method and special apparatus for getting large nutmeat pieces from the nut (also known as Black Walnuts) of the Eastern Black Walnut (Juglans nigra) tree utilizing a special apparatus to saw grooves on the nutshell that make new fault lines parallel to and on each side of the internal partition of the nutshell. Said sawn grooves allow for tensional force to open the nutshell in three pieces resulting in the exposure of large nutmeat pieces for easy pick-out removal. This method eliminates the need for compression force to crack the nutshell.

### BACKGROUND OF INVENTION

Black Walnuts, which come from the eastern black walnut tree, (Juglans nigra) produce nuts that have a strong outer shell which makes harvesting the nutmeat in large pieces difficult. Current processing techniques for these nuts rely on compression or cracker techniques that exert high compressive force in order to crack the shells. This compressive force results in a crushing action which fractures the shell and nutmeat into many randomly shaped small pieces. The natural fault lines of the nutshell do not allow for optimally opening the nutshell cavity to expose large nutmeat kernels.

There are two nutmeat cavities within the nutshell separated by an internal partition between these two cavities. The natural fault lines cross these cavities in an adverse manner and cause the nutshell and nutmeat to fracture into small pieces during the conventional cracking process. Nutmeat pieces that are large are more desirable and small nutmeat pieces.

### BRIEF SUMMARY

This invention is a method for obtaining large kernels of nutmeat from Black Walnuts by firstly sawing two substantially parallel cuts on both ends of the Black Walnut with a special apparatus and secondly, using tensional force to pry the nut open utilizing the sawn groves as the fault lines for separating the nut shell and thereby exposing large kernels of the nutmeat. The tensional force is applied in two places which results in the nut shell being separated into three pieces. The three pieces are described as two being the sides of the nut shell and one comprising mainly of the internal partition of the nut shell.

### DESCRIPTION OF DRAWINGS

In FIG. 1 the black walnut is viewed from the end showing the two nutmeat cavities (2) lying within the nutshell indicated by dashed lines and they are separated by an internal partition (3) also indicated by dashed lines. The natural fault line (1) is situated across these cavities and can be seen as a small crack in the outer nutshell. This fault line which lies substantially perpendicular to the internal partition (1) and gives rise to cracking across the nutmeat cavities (2) which results in cracking the nutmeat into undesirable small pieces when conventional compressive force is used to crack the nutshell as is normal in the industry.

In FIG. 2 the side of the nut is viewed parallel to the internal partition (3) Indicated by dashed lines. Also shown and indicated by dashed lines is the internal partition (3).

In FIG. 3 the nut is view both parallel to the internal partition (3) on the left and also perpendicular to the internal partition on the right. The new fault lines in the nutshell are introduced with optimally placed sawn grooves (4). These sawn grooves (4) are placed substantially parallel to each side of the internal partition (3) of the nutshell and are sawn on each end of the nut.

FIG. 4 shows the separation procedure for opening one side of the nutshell. This is accomplished by the insertion of a prying tool (5) into the sawn groove (4) and a tensional force in the direction of arrow (f1) is used to separate one nutshell-side (6)

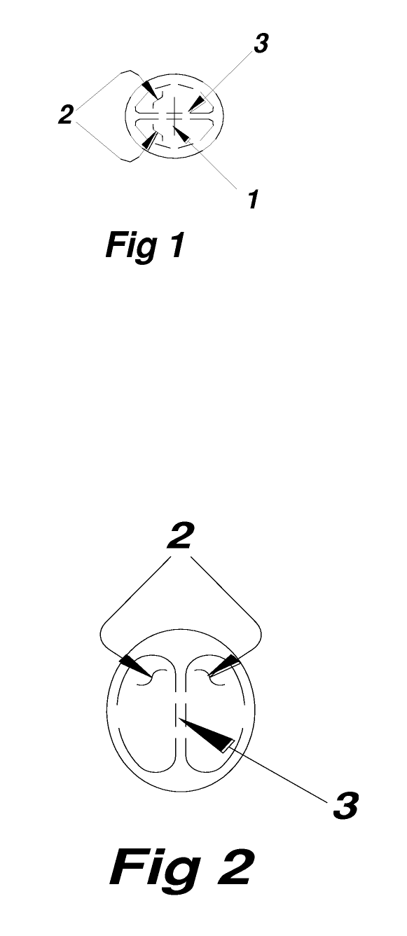

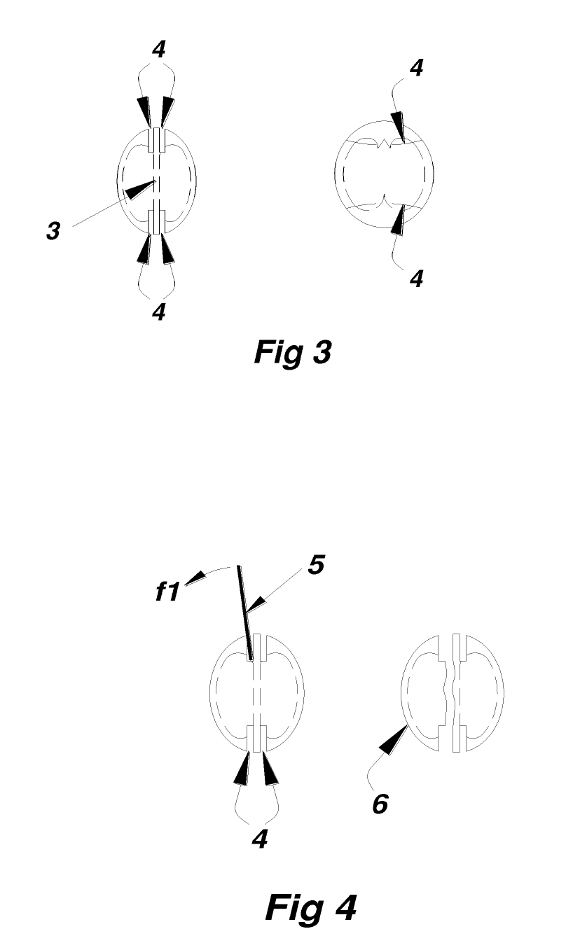

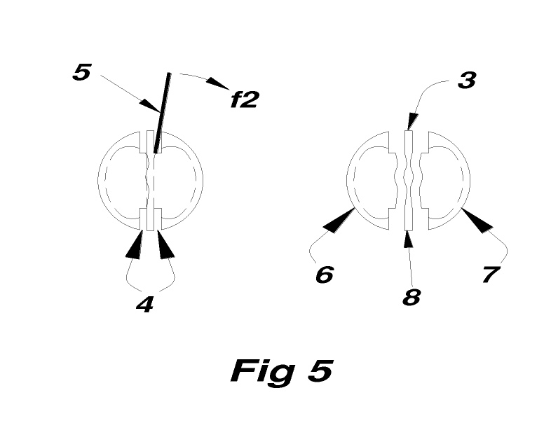

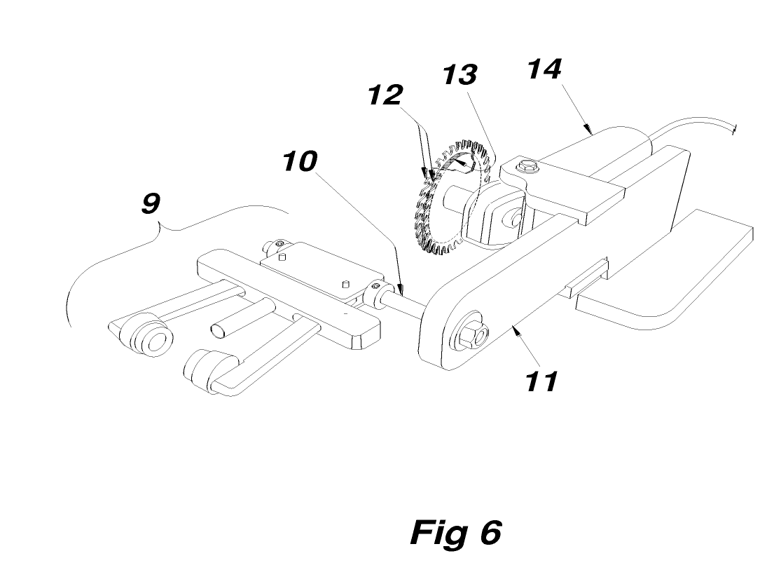

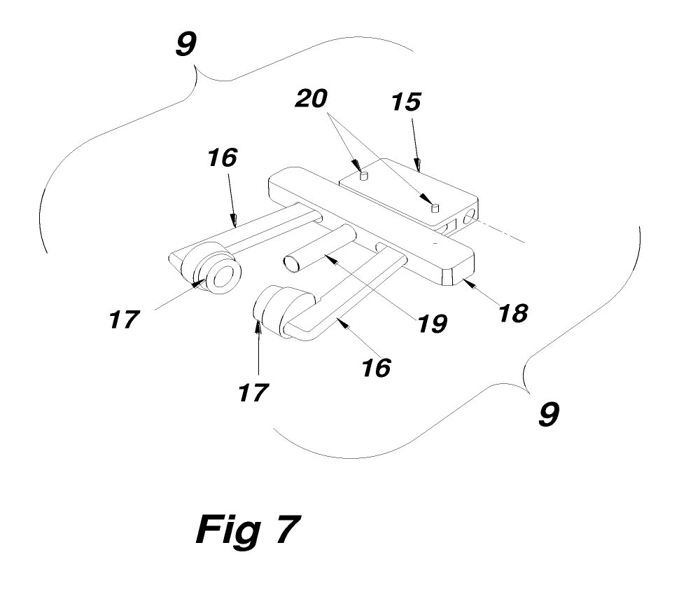

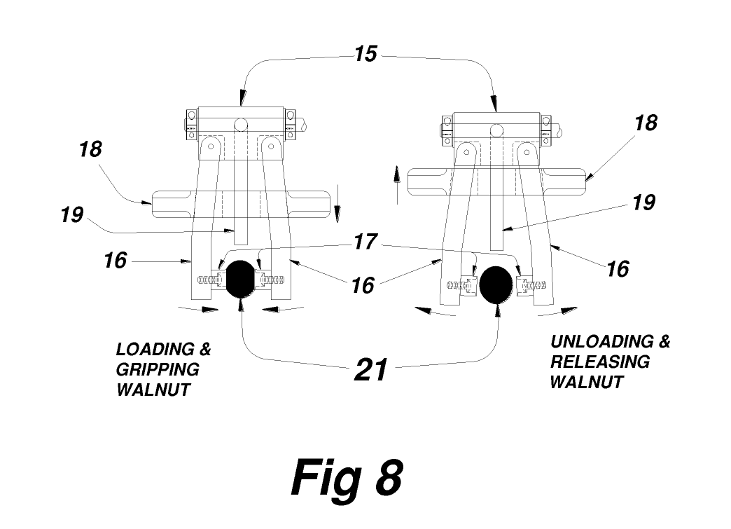

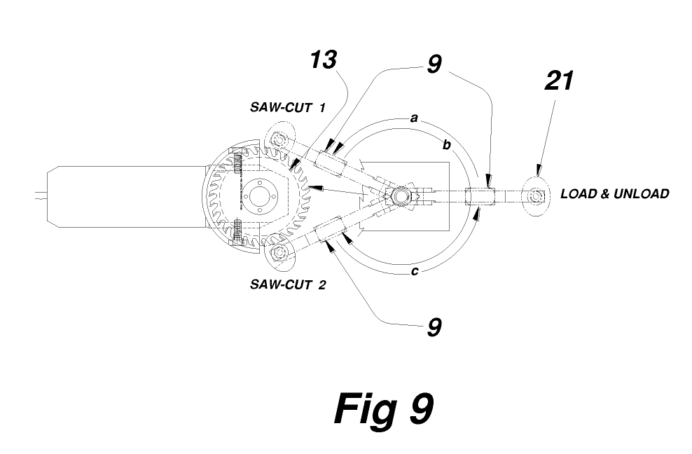

In FIG. 5 the opposite nutshell-side (7) can be separated by inserting the prying tool into the opposite sawn groove (4) and a tensional force is applied in the direction of arrow (f2). These two tensional force applications (f1 shown in FIGS. 4 and f2 shown in FIG. 5) results in the nutshell being separated into three pieces as shown by (6), (7) and (8). This manner of separation is oriented substantially parallel to each side of the internal partition (3) and is the main thrust of the invention and results in nutmeat that is exposed in large pieces which can be easily picked out of one or more of the three nutshell pieces. The nutmeat may fall out when the three nutshell pieces (6), (7) and (8) are separated or they may cling to one or more of these three pieces and can easily be picked out with an ordinary nut pick.

FIG. 6 shows the special apparatus for making the sawn grooves (4) shown in FIG. 3 on the nut of the Eastern Black Walnut. FIG. 6 further shows The Swing arm Assembly (9) which is used for holding the nut tightly and for presenting the nut to the saw blades for sawing. This Swing Arm Assembly (9) is mounted on and pivots or swings around the Pivot Bolt (10). The Pivot Bolt (10) is attached substantially perpendicular to the side plate (11). The Saw Motor (14) is a typical angle-grinder with the grinder-disc replaced by two Sawing Blades (12) that have a Spacer (13) to set the proper distance between these saw blades. The Spacer (13) is of sufficient diameter so as to limit a depth of saw-cut which is seen in the cut-away portion of the saw blade in FIG. 6.

FIG. 7 and FIG. 8 show the components of the Swing Arm Assembly (9). These can be manufactured from wood, wood composite material, or metal. The Pivot Block (15) has a Center Guide Pin (19) oriented substantially perpendicular to the mounting hole that fits on the Pivot Bolt (10) shown in FIG. 6. Attached to the Pivot Block (15) are two Gripper Arms (16) each having hinging attachment to the Pivot Block (15) by mean of a Hinge Pin (20). Each Gripper Arm (16) has a Rubber Nut Gripper (17) attached to the opposite end from the hinge pin attachment. The Slide Bar (18) is a movable piece that is guided on the Center Guide Pin (19) by means of a central hole. The Slide Bar also has two elongated holes that allow the Gripper Arms (16) to pass through. The Gripper Arms (16) are spaced apart on one end by the hinge pin attachment (20) and the spacing on the opposite end is controlled by the position of the Slide Bar. As the Slide Bar is moved toward the end of the Center Guide Pin (19) the ends of the Gripper Arms (16) that have the Rubber Nut Grippers on them become closer together each closing symmetrically about the axis of the Center Guide Pin. Thus, different sizes of nuts can be gripped while maintain the center of the nut alignment to the Center Guide Pin (19). The Rubber nut grippers are of elastomeric material that provide positive holding to the surface of the nutshell.

FIG. 8 shows how moving the Slide Bar along the Center Guide Pin (19) cause the Rubber Nut Grippers (17) to move closer together and thus grip and hold the Nut (21) during the loading, and groove sawing operation. When the sawing is complete, the Slide Bar (18) is moved toward the Pivot Block (15) which allows the Rubber Nut Grippers (17) to move farther apart and the nut is released and unloaded.

FIG. 9 is a view perpendicular to the side of the saw blades and shows different positions of the Swing Arm Assembly (9) during the process of sawing the nut. The progression of the Swing Arm Assembly (9) is, firstly, the Load & Unload position. This is the position in which the nut is loaded with the Internal Partition (3) (see FIG. 1) is loaded substantially parallel to the saw blades by orienting the nut correctly and moving the Slide Bar (18) to grip and hold the Nut (21). Secondly, the nut is sawn on one end by first rotating the Swing Arm Assembly (9) in the direction of arrow “a” until the nut encounters the saw blades and the sawing proceeds until the nut contacts the Spacer (13) which limits the nut from being sawn deeper. Thirdly, the process continues by rotating the Swing Arm Assembly (9) in the direction of arrow “b” which presents the opposite end of the nut to the saw blades for sawing. The sawing proceeds until the nut encounters the Spacer (13) and fourthly, the Swing Arm Assembly (9) is rotated in the direction of arrow “c” back to the load and unload position at which point the Slide Bar (18) is moved toward the Pivot Block (15) which allows the Rubber Grippers (17) to open and the Nut is released.

### DETAILED DESCRIPTION AND BEST MODE OF IMPLEMENTATION

The special apparatus has two Nut Grippers attached to a pivoting swing-arm assembly. The Nut Grippers are of elastomeric material which grip and hold the nut for sawing. The nut is oriented by placing the internal-partition of the nut parallel to the sawing blades.

The nut has three distinctive areas on the outer nutshell that are indicators for the orientation of the internal partition of the nut. By identifying these indicators, one can easily orient the nut for proper placement in the Nut Gripper of the special apparatus. The proper placement is achieved when the internal partition is substantially parallel to the sawing blades. The first two of these indicators are the two ends of the nut. The ends of the nut can be identified as the point in which the surface grain pattern on the outside of the nutshell comes to a point on each end. There is also a small crack area, on most nuts but not all, on the bottom of the nut that crosses the bottom point. The third indicator is the nut thickness—when holding the nut, by the ends previously described, by ones thumb on one nut-end-point and forefinger on the other nut-end-point the nut can be rotated with the axis of rotation passing through the nut-ends. When rotating the nut as described, the nut is observed has having two different areas of diametrical thickness—one being narrow thickness which is associated with the flatter sides of the nut. The proper placement of the nut into the nut grippers is achieved when the narrow diametrical sides of the nut are parallel to the rubber nut grippers and the axis, otherwise described as an imaginary line that passes through the nut end-points is perpendicular to the guide pin of the Swing Arm Assembly of the special apparatus. The placement of the nut in the Nut Grippers as described will have the nut's internal partition parallel to the sawing blades and the internal partition will be centered between the two Sawing Blades. The nut can be placed in the Nut Grippers with either the top end-point up or the bottom end-point up as long as the imaginary line that passes through the nut end-points is perpendicular to the guide pin.

The nut oriented as described and held by the Nut Grippers is then presented for sawing two grooves on one end of the nut and then rotated by means of the Swing Arm Assembly for sawing two grooves on the opposite end of the nut. There are two sawing blades spaced apart by a spacer which controls both the spacing of the sawing blades and is of sufficient diameter to limit the depth of the sawn grooves. The space between the two saw blades can be from 0.10 to 0.50 inches and preferably 0.250 inches which results in corresponding sawn grooves on the nutshell. The width of the grooves is determined by the width of the saw blades and the resulting sawn grooves are 0.01 to 0.200 inches wide and preferably 0.06 inches wide.

Proper orientation of the nut to the nut grippers is achieved when the two sawn grooves are substantially parallel to and on each side of the nut shell's internal partition. The depth of the sawn grooves is 0.125 inches to 0.750 inches deep and optimally 0.450 inches deep at the ends of the nut. The saw blades configuration can either be a band saw that produces a straight cut or a radial saw that produces a radial cut with preference of a radial saw that is 2.0 inches to 8.0 inches in diameter and optimally 4.375 inches in diameter.

The nut is removed from the nut grippers and thus removed from the special apparatus after the sawn grooves are accomplished.

After the nut, with the aforementioned sawn grooves, is removed from the special apparatus, the nutshell is separated into three pieces firstly by applying tensional force in one sawn groove by means of inserting a blade shaped hand-tool into the sawn groove and prying. A typical 5-in-1 painter's tool is one type of hand tool that works well for this purpose. This hand-tool is also known as a 6-in-1 painter's tool and either of these hand-tools can be found at most hardware stores. Other hand-tools with a blade used for prying can be used. This tensional force is done in two places on the nut shell which causes the nutshell to separate into three pieces. The two tensional forces can occur one after the other or they can be done simultaneously. Optionally, the tensional force may come from wedging by the insertion of 1 to 4 wedges into the sawn grooves with sufficient force to and separate the nutshell into the three pieces described.

While the present apparatus invention is conceive for low volume use, also, conceived is a higher volume apparatus or machine in which the nut is automatically oriented and gripped and then transported to groove-sawing stations that would cut the grooves in each end and optionally on the sides of the nut and then is passed on to a nutshell fracturing station in which the nutshell would be separated into three pieces. While the speed of this machine is improved the concept of sawing groove substantially parallel to and on each side of the nut's internal partition is maintained in order to cause the nut to be opened for exposure of large nutmeat pieces.

While the present invention is conceived for two grooves sawn into each end of the nut also conceived is these grooves sawn on the sides of the nut as extension of the sawn grooves or separately sawn grooves. These grooves could extend fully around the nut or partially. The sawn grooves on the side of the nut would be of a similar spacing and parallel to the internal partition of the nut as the sawn grooves on the end. The depth of the grooves on the side-nut area is less than the end nut area because the internal nutmeat is closer to the outside of the nut in the side-nut area. The depth of cut in the side-nut area is 0.020 to 0.400 inches and preferably 0.125 inches.

1. A method for opening the nutshell of the Eastern Black Walnut tree (Juglans nigra) that comprises firstly, the introduction non-natural fault lines in the Nutshell that are substantially parallel to and on each side of the internal partition of the nut by sawing two grooves on each end of the nutshell and secondly, the use of tensional force to open the nutshell by breaking along the sawn-groove-fault lines and thereby exposing large kernels of nutmeat that may be easily picked out.

2. An improved method for opening the nutshell of the Eastern Black Walnut tree (Juglans nigra) that eliminates the need for compression force to crack the nutshell.

3. A special apparatus for holding and sawing grooves in the nutshell of the Eastern Black Walnut that allows the nutshell to be separated into three pieces and exposes the nutmeat in large kernels.

4. Special nut grippers for holding and sawing the Eastern Black Walnut that involves elastomeric grippers made from elastomeric materials such as rubber, thermos-plastic rubber, or urethane.

5. A nut holding system that allows for gripping different size nuts while keeping the center of nut aligned substantially in the same plane.

6. A pivot block and nut holding mechanism that allows for presenting first one end of the nut to sawing blades for sawing grooves by a rotational movement and then presenting the opposite end of the nut to these same sawing blades by means of a rotational movement in the opposite direction for sawing grooves and maintaining grip on the nut during both sawing operations.
